(19) United States
(12) Patent Application Publication
(10) Pub. No.: US 2024/0301928 A1
(43) Pub. Date: Sep. 12, 2024

(54) FRICTION BRAKE, ESPECIALLY FOR MOTOR VEHICLES

(71) Applicant: Johann FIMBINGER, Kalsdorf (AT)

(72) Inventor: Johann FIMBINGER, Kalsdorf (AT)

(21) Appl. No.: 18/666,464

(22) Filed: May 16, 2024

Related U.S. Application Data
(63) Continuation of application No. PCT/EP2022/077062, filed on Sep. 28, 2022.

(30) Foreign Application Priority Data
Nov. 17, 2021 (DE) 10 2021 130 045.2

(51) Int. Cl. F16D 65/12; B23K 26/342

(52) U.S. Cl. CPC F16D 65/127; F16D 65/125; B23K 26/342; F16D 2200/0013; F16D 2250/0046; F16D 2250/0076

(57) ABSTRACT

A friction brake is provided for motor vehicles such as road vehicles, rail vehicles and utility vehicles, the friction brake including a friction brake body, especially a grey iron brake disk, the friction surface of which has been provided with an antiwear layer of an iron alloy that has been applied to the friction surface by thermal spraying or deposition welding, especially by laser deposition welding. The antiwear layer includes, as alloy constituents, predominantly iron (Fe) as residual constituent, and also carbon (C), vanadium (V), and optionally chromium (Cr) and/or niobium (Nb) and/or molybdenum (Mo) and/or tungsten carbide (WC).

### CROSS REFERENCE TO RELATED APPLICATIONS

This application is a continuation under 35 U.S.C. § 120 of International Application PCT/EP2022/077062, filed Sep. 28, 2022, which claims priority to German Application No. 10 2021 130 045.2, filed Nov. 17, 2021, the contents of each of which are incorporated by reference herein.

### FIELD OF THE INVENTION

The invention relates to a friction brake, especially for motor vehicles such as road, rail and utility vehicles, comprising a friction-brake body, especially a gray cast iron brake disk (1), the friction surface (5) of which is provided with a wearing layer (6) of an iron alloy, which is applied on the friction surface (5) by thermal spraying or buildup welding, especially by laser buildup welding and which as alloy constituents comprises predominantly iron (Fe) as the residual constituent as well as a selection of further alloy components.

### BACKGROUND

The invention relates to a friction brake, especially for motor vehicles such as road, rail and utility vehicles, comprising a friction-brake body, especially a gray cast iron brake disk (1), the friction surface (5) of which is provided with a wearing layer (6) of an iron alloy, which is applied on the friction surface (5) by thermal spraying or buildup welding, especially by laser buildup welding and which as alloy constituents comprises predominantly iron (Fe) as the residual constituent as well as a selection of further alloy components, which can be inferred from the claims.

Such wearing layers—more recently also known as wear-protection layers—form the friction surfaces on brake disk bodies of motor vehicles of the said type. They consist advantageously of iron-alloy compositions which, due to high hardness with appropriately improved abrasion resistance, are suitable as wear-protection coating for conventional brake disks of steel or gray cast iron.

On the one hand, it is possible with such iron alloys to achieve, in braking operation, advantageous friction values as close as possible to the ideal of uncoated gray cast iron brake disks.

An advantage related to this is reduced wear and corrosion of the brake disk as well as less emission of fine dust into the environment from the brake lining of the brake calipers.

As a consequence of the achieved reduction of wear of the friction surface, the thickness of the brake disk as such may also be significantly decreased and the associated CO2 emission can also be correspondingly reduced both during fabrication and in ongoing braking operation.

The said advantages with respect to environmental pollution and the improved service life of such known friction-brake bodies have triggered advanced developments in automotive engineering and have justified corresponding investments. Especially due to the use of new fabrication techniques for cost-efficient series manufacture of wear-protection layers through the use of known techniques such as PTA (plasma transfer arc powder coating) and HVOF (high velocity oxygen fuel spraying), it has become possible to successfully describe approaches toward implementation of legal requirements, such as demonstrated by the following examples from the prior art.

WO2020/173756 A1 describes a brake disk with a wear-protection layer predominantly of steel and with at least two elements selected from a group of nitride formers, namely chromium, molybdenum, vanadium and aluminum. The formation of nitride results in a wear-protection layer of high surface hardness, by which wear and especially abrasion at the friction-contact surface are reduced. The base body of this brake disk is a gray cast iron body which, during fabrication of the wear protection layer, is applied on the base body of gray cast iron in two coating steps by thermal spraying and subsequent diffusion treatment with the objective of increasing the corrosion resistance on the one hand and the hardness of the coating on the other hand. It is only by the diffusion treatment that the penetrating nitrogen atoms form, with the proposed elements, nitrides that ensure the desired surface hardness. Further elements such as carbon and/or manganese will also be present in the wear protection coating, at the most as impurities.

EP 3117025 B1 likewise relates to a wear protection layer comprising an iron alloy on a brake disk of gray cast iron. The main alloy constituents consist of 0.5 to 2 wt % carbon, 3 to 13 wt % aluminum and optionally 0.5 to 5 wt % chromium. In addition, further alloy constituents such as Si, Mn, Ni, W, V, Nb and/or B are optionally conceivable, together with a residual content of iron as well as with further trace impurities typical of steel.

Because of aluminum as a main alloy constituent, the application of the protective layer is limited to the technique of thermal spraying and, in addition, because of the presence of aluminum, intermetallic brittle phases that impair the strength of the protective layer have to be tolerated.

Other known solutions, such as, for example, according to US 2020/0072306 A1, are provided in a brake disk of gray cast iron not only with a wear protection layer but also with a corrosion protection layer. The wear protection layer comprises an iron-base alloy together with further alternative alloy constituents of vanadium niobium, boron or chromium carbides.

Finally, multiply coated brake disks are known, such as, for example, according to US 2017/0122392 A1 with a wear protection layer and a top layer on a gray cast iron brake disk, wherein the top layer contains a component of ceramic in an NiCrMo matrix.

DE 102019212844 A1 relates to a gray cast iron brake disk for terrestrial vehicles with a corrosion protection layer, on which a wear protection layer is applied. This consists of silicon carbide (SiC) with hard metal reinforcement of vanadium, niobium, boron or chromium carbide.

The hardness of the wear protection layer depends on the carbide inclusions, which are embedded in a soft ferritic matrix.

In order to prevent martensitic hardening and embrittlement of the metallic matrix by enrichment with carbon, the application of a buildup welding technique necessitates a feed of a separately manufactured carbide powder, in which the carbon content is low except for residual quantities that technically can be avoided only with difficulty.

An object underlying the present disclosure is to create a further improvement of a friction brake without a separate corrosion protection layer but with high wear resistance and durable efficiency. In particular, this concerns the special requirements for friction brakes of rail vehicles, for the manufacture of which it is preferable for cost reasons to use laser coating and which ensure particularly long maintenance intervals.

### SUMMARY

This object may be achieved in accordance with this disclosure, and it is noted that various material combinations are contemplated, including:
carbon (C), vanadium (V) and chromium (Cr);
carbon (C), vanadium (V) as well as niobium (Nb) and/or molybdenum (Mo);
carbon (C), vanadium (V) as well as molybdenum (Mo) and/or tungsten carbide (WC), and
carbon (C), vanadium (V) as well as tungsten carbide (WC) and/or niobium (Nb).

As far as these variants are concerned, it is notable that the chemical elements may change their microstructure in the molten phase of the coating produced by spraying or buildup welding.

Beyond that, it may be advantageous to substitute certain elements completely or partly, such as, for example, tungsten by tungsten carbide (WC) or carbon partly by the element boron, in which case the carbon contained in the gray cast iron base material of the brake disk is leached out measurably from the gray cast iron substrate. Similarly to vanadium, addition of boron promotes the ductility of the alloy.

If a high carbon content in the melt is desired, for example to obtain a particularly high hardness of the wearing layer, it will be necessary to choose a high carbon content in the powered mixture of raw materials for the alloy constituents.

Special hardness-promoting agents such as the addition of alloy constituents of the elements vanadium (V), niobium (Nb), tungsten (W) or molybdenum (Mo) may indeed further improve the wear resistance of the coating, but are more costly than an alloy composition comprising the elements carbon, vanadium and chromium together with iron (Fe) as the residual alloy constituent.

This same consideration applies analogously for the complete or partial substitution of the alloy constituents chromium (Cr) by alloy constituents such as niobium (Nb), tungsten (W)—the latter preferably as tungsten carbide (WC)—and molybdenum (Mo), with which the abrasion resistance can be further improved provided higher production costs are acceptable. In this connection, it is always important to comply with special mixing ratios.

In one advantageous variant, it is provided that, as regards the respective alternative alloy composition, the wearing layer contains as alloy constituents
at least 12 wt % chromium (Cr)
at least 1.0 wt % vanadium (V)
at least 1.0 wt % carbon (C) or
at least 0.4 wt % boron (B).

Because of the high brake energy introduced into the friction surfaces during a braking process, it is sufficient to dimension the layer thickness of the wearing layer as approximately 2 to 4 mm.

To ensure that the introduction of heat into the brake disk can take place as fast as possible, it is advantageous to adapt the thickness of the brake disk appropriately, preferably by ensuring that the ratio between the layer thickness of the wearing layer and the thickness of the coated substrate of the brake disk is dimensioned as approximately 1:5 to 1:7.

By ensuring the respective alloy composition of the wearing layer, it is possible to generate the necessary braking action intermittently and to quickly guide the heat rapidly into the brake disk. This same consideration applies both for friction-brake bodies coated on one side or on both sides. Depending on application situation, this applies both for the gray cast iron brake disk, described here by way of example, of motor vehicles such as road, rail or utility vehicles and for comparable application situations such as wind power systems.

In the case of wind power systems, a distinction can be made between two brake systems. A first brake system is used for braking the rotors. The brake for this brake system is seated on the power take-off of the rotors. Here, the brake functions to slow the rotor rotation to low rpm of the brake disk in a manner as free of vibrations as possible and to control the associated high production of fine dust pollution caused by abrasion of organic brake material. The second brake system is intended for the generator drive. In this case, the brake disks have relatively small diameter and sintered brake linings of a brass alloy are used for the brake calipers, i.e. problems of abrasion (fine dust) and noise generation are of special concern here.

As a particular advantage of the wearing layer proposed according to the disclosure, it has been proved on the test stand that, compared with a blank, i.e. uncoated friction-brake body of gray cast iron, it is not only the desired reduction of the wear values that is achieved. In the tests of friction values, it has been further proved that even the friction values of an uncoated gray cast iron brake disk, i.e. its desired braking effect, are achieved. In this connection, due consideration is to be given to the type of application of the alloy constituents, which preferably exist in powder form, by using suitable process techniques. As such, preferably buildup welding and flame spraying are conceivable, the latter especially due to application of the known high-speed flame spraying technique or by use of the known atmospheric plasma spraying technique. Those techniques are particularly suitable for ensuring durable adhesion on a friction-brake body structure—preferably roughened at the surface—and for producing a wearing layer of high hardness with sufficient ductility. For iron alloy compositions applied as powder, preferably the laser application technique and thermal powder plasma spraying are suitable. These are known techniques that additionally ensure homogeneous quality of the finished wear-protection coating. Their achievable surface hardness exceeds that of the conventional gray cast iron brake disk by a factor of 2 to 3.

However, the use of the coating technique by wire buildup welding also proves to be suitable, provided that desired material compositions are available. This technique is clean and loss-free, but needs controlled, precise energy input.

### BRIEF DESCRIPTION OF THE DRAWING

In the following, an exemplary embodiment with a friction-brake body in the form of a conventional gray cast iron brake disk as the base body and an inventive wear-protection layer is described for two different variants on the basis of the drawings.

FIG. 1 shows a shaft-mounted brake disk in three-dimensional representation; and

FIG. 2 shows a half section through a railroad wheel with brake disk as well as a sectional enlargement A.

### DETAILED DESCRIPTION OF THE PREFERRED EMBODIMENTS

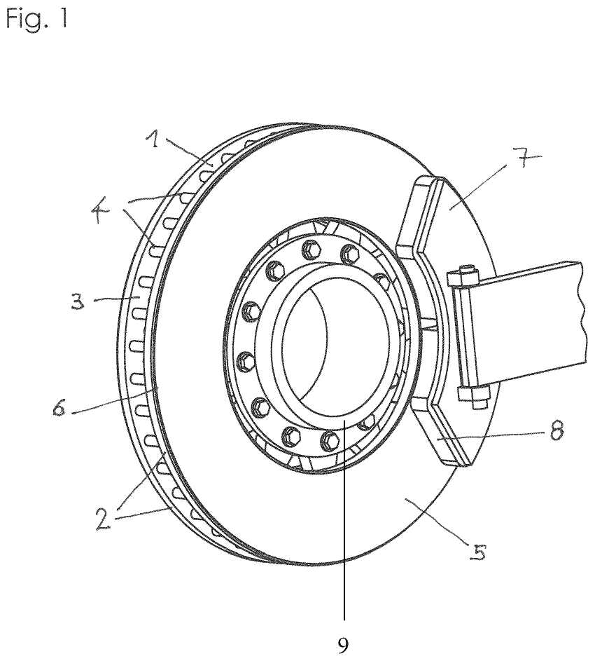

The embodiment of a friction brake according to FIG. 1 is suitable not only for use on motor vehicles such as road or utility vehicles but also as a shaft-mounted brake disk, for example also on turbines of wind-power systems or generally in connection with rotary drives.

Brake disk 1 illustrated in FIG. 1 comprises two outer disks 2, which form a cast iron part by means of a connecting web 3. On its circumference, connecting web 3 has openings 4, which function for cooling of the heating of the brake disk 1 generated by action of the braking forces. The annular friction surface 5 of the brake disk 1 has a wearing layer 6, which is represented by a double line and which is applied on brake disk 1 by buildup welding to form the friction surface 5 thereof. Wearing layer 6 is applied on the cast iron structure of the brake disk 1 by buildup welding of an alloy powder or as wire according to a plasma spraying technique, wherein the starting material respectively has a predetermined alloy composition. The alloy constituents thereof consist predominantly of iron as residual constituent and of the further alloy constituents carbon, vanadium and chromium, possibly replaced or supplemented by further alloy constituents that satisfy the requirements of wearing layer 6.

The braking action is triggered by means of preferably pneumatically actuatable brake calipers 7, which act on one side or on both sides against brake disk 1 by means of a brake lining 8 fixed on the brake caliper 7, opposite the friction surface 5 rotating with brake disk 1.

Brake disk 1 is shrink-fitted on an axle or shaft, not shown, such that it rotates therewith. A wheel-disk hub 9 bolted together with brake disk 1 is used for this purpose.

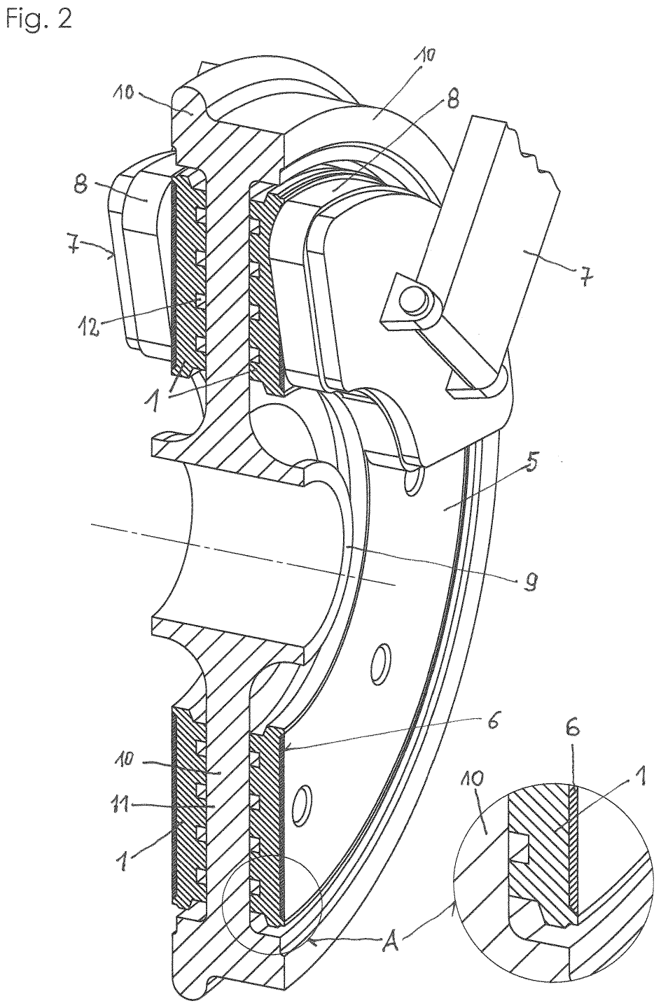

FIG. 2 shows, in a half section, a wheel disk 10 of a rail vehicle with rolling profile corresponding to the track structure. A brake disk 1, which has circumferential vent ducts 12 on the insides facing web profile 11, is fixed on each of both outer sides of web profile 11 of wheel disk 10.

A wearing layer 6, which on its outside forms the friction surface 5 for a brake caliper 7, is applied on each outer side of brake disk 1. According to the exemplary embodiment shown for the railroad wheel illustrated in the drawing, a brake lining 8—also known by the term brake pad and usually consisting of a composite material—facing the friction surface 5 is fixed on each brake caliper 7. During running operation, brake calipers 7 are set to a short distance from friction surface 5. During their actuation in the braking situation, brake linings 8 are usually pressed pneumatically against friction surface 5, whereby wheel disk 10 is braked, if necessary to a stop, in a manner corresponding to the pressing force.

As already explained in connection with FIG. 1, wearing layer 6 is applied on the base material—consisting of cast steel or gray cast iron—of wheel disk 10 by thermal spraying or buildup welding, especially by laser buildup welding. Friction surface 5 is formed by subsequent mechanical machining of the outer surface of wearing layer 6.

In contrast to FIG. 1, wheel-disk hub 9 in the embodiment according to FIG. 2 is formed in one piece on the casting constituting wheel disk 10.

A sectional enlargement A shows the details of the assembly of wheel disk 10 together with brake disk 1, which is coated with wearing layer 6.

In a conventionally designed friction-brake body on a vehicle, friction surface 5 is adapted to the geometry of brake disk 1, so that abrasion involving friction surface 5 is extensively reduced in the area of frictional contact between wearing layer 6 and brake lining 8 fastened on brake caliper 7. A comprehensive investigation on a test stand using a single gray cast iron brake disk of a heavy commercial vehicle as an example has shown a significant reduction of the wear values due to the use of a wearing layer 6 proposed. When measured in terms of the reduction of the quantity of fine dust, a decrease of approximately 50 wt % was found during use of the same brake lining 8.

In that case, a conventional brake lining on the sides of the brake calipers 7 was used in combination with a wearing layer 6 in the form of a powder coating with a selection of alloy constituents proposed.

What is claimed is:

1. A friction brake, especially for motor vehicles such as road, rail and utility vehicles, comprising a friction-brake body, especially a gray cast iron brake disk, the friction surface (5) of which is provided with a wearing layer (6) of an iron alloy, which is applied on the friction surface (5) by thermal spraying or buildup welding, especially by laser buildup welding and which as alloy constituents comprises predominantly iron (Fe) as the residual constituent,
as well as carbon (C), vanadium (V) and optionally
chromium (Cr) and/or niobium (Nb) and/or molybdenum (Mo) and/or tungsten carbide (WC), wherein the wearing layer (6) contains as alloy constituents
at least 12 wt % chromium (Cr)
at least 1.0 wt % vanadium (V) and
at least 1.0 wt % carbon (C).

2. The friction brake of claim 1, wherein boron (B) is present in the wearing layer (6).

3. The friction brake of claim 1, wherein the wearing layer (6) is applied in one or more layers and has a total thickness of 2 to 4 mm.

4. The friction brake of claim 1, wherein the wearing layer (6) is produced by powder buildup welding.

5. The friction brake of claim 1, wherein the wearing layer (6) is applied by flame spraying.

6. The friction brake of claim 1, wherein the wearing layer (6) has a surface hardness that is higher than that of the gray cast iron brake disk by a factor of 2 to 3.

7. A friction brake, especially for motor vehicles such as road, rail and utility vehicles, comprising a friction-brake body, especially a brake disk of gray cast iron (GG), the friction surface (5) of which is provided with a wearing layer (6) of an iron alloy, which is applied on the friction surface by thermal spraying or buildup welding, especially by laser buildup welding and which as alloy constituents comprises predominantly iron (Fe) as the residual constituent, characterized in that the wearing layer (6) further comprises carbon (C), vanadium (V) and chromium (Cr).

8. The friction brake of claim 7, wherein boron (B) is present in the wearing layer (6).

9. The friction brake of claim 7, wherein the wearing layer (6) is applied in one or more layers and has a total thickness of 2 to 4 mm.

10. The friction brake of claim 7, wherein the wearing layer (6) is produced by powder buildup welding.

11. The friction brake of claim 7, wherein the wearing layer (6) is applied by flame spraying.

12. The friction brake of claim 7, wherein the wearing layer (6) has a surface hardness that is higher than that of the gray cast iron brake disk by a factor of 2 to 3.

13. A friction brake, especially for motor vehicles such as road, rail and utility vehicles, comprising a friction-brake body, especially a brake disk of gray cast iron (GG), the friction surface (5) of which is provided with a wearing layer (6) of an iron alloy, which is applied on the friction surface (5) by thermal spraying or buildup welding, especially by laser buildup welding, and which as alloy constituents comprises predominantly iron (Fe) as the residual constituent, characterized in that the wearing layer (6) further comprises carbon (C), vanadium (V),
as well as niobium (Nb) and/or molybdenum (Mo).

14. The friction brake of claim 13, wherein boron (B) is present in the wearing layer (6).

15. The friction brake of claim 13, wherein the alloy constituents niobium (Nb) and molybdenum (Mo) together amount to at most 2 vol % of the wearing layer (6).

16. The friction brake of claim 13, wherein the wearing layer (6) is applied in one or more layers and has a total thickness of 2 to 4 mm.

17. The friction brake of claim 13, wherein the wearing layer (6) is produced by powder buildup welding.

18. The friction brake of claim 13, wherein the wearing layer (6) is applied by flame spraying.

19. The friction brake of claim 13, wherein the wearing layer (6) has a surface hardness that is higher than that of the gray cast iron brake disk by a factor of 2 to 3.

20. A friction brake, especially for motor vehicles such as road, rail and utility vehicles, comprising a friction-brake body, especially a brake disk of gray cast iron (GG), the friction surface (5) of which is provided with a wearing layer (6) of an iron alloy, which is applied on the friction surface (5) by thermal spraying or buildup welding, especially by laser buildup welding, and which as alloy constituents comprises predominantly iron (Fe) as the residual constituent, characterized in that the wearing layer (6) further comprises carbon (C), vanadium (V),
as well as molybdenum (Mo) and/or tungsten carbide (WC).

21. The friction brake of claim 20, wherein boron (B) is present in the wearing layer (6).

22. The friction brake of claim 20, wherein the wearing layer (6) is applied in one or more layers and has a total thickness of 2 to 4 mm.

23. The friction brake of claim 20, wherein the wearing layer (6) is produced by powder buildup welding.

24. The friction brake of claim 20, wherein the wearing layer (6) is applied by flame spraying.

25. The friction brake of claim 20, wherein the wearing layer (6) has a surface hardness that is higher than that of the gray cast iron brake disk by a factor of 2 to 3.

26. A friction brake, especially for motor vehicles such as road, rail and utility vehicles, comprising a friction-brake body, especially a brake disk of gray cast iron (GG), the friction surface (5) of which is provided with a wearing layer (6) of an iron alloy, which is applied on the friction surface (5) by thermal spraying or buildup welding, especially by laser buildup welding and which as alloy constituents comprises predominantly iron (Fe) as the residual constituent, characterized in that the wearing layer (6) further comprises carbon (C), vanadium (V)
as well as tungsten carbide (WC) and/or niobium (Nb).

27. The friction brake of claim 26, wherein boron (B) is present in the wearing layer (6).

28. The friction brake of claim 26, wherein the wearing layer (6) is applied in one or more layers and has a total thickness of 2 to 4 mm.

29. The friction brake of claim 26, wherein the wearing layer (6) is produced by powder buildup welding.

30. The friction brake of claim 26, wherein the wearing layer (6) is applied by flame spraying.

31. The friction brake of claim 26, wherein the wearing layer (6) has a surface hardness that is higher than that of the gray cast iron brake disk by a factor of 2 to 3.
